(19) United States
(12) Patent Application Publication
(10) Pub. No.: US 2017/0167432 A1
(43) Pub. Date: Jun. 15, 2017

(54) METHOD AND APPARATUS FOR COOLING A CYLINDER HEAD

(71) Applicants: Perusahaan Otomobil Nasional Sdn Bhd, Subang Jaya (MY); Ricardo UK Limited, Shoreham-By-Sea (GB)

(72) Inventors: Mohd Suffian Sahadan, Kuala Lumpur (MY); Gordon Taylor, Shoreham-By-Sea (GB)

(21) Appl. No.: 15/408,921

(22) Filed: Jan. 18, 2017

Related U.S. Application Data
(62) Division of application No. 14/409,029, filed on Dec. 18, 2014, now abandoned.

(30) Foreign Application Priority Data
Jun. 18, 2012 (MY) PI 2012002752

(51) Int. Cl. F02F 1/38; F01P 3/02; F02F 1/42; F01P 3/14; F02F 1/24

(52) U.S. Cl. CPC F02F 1/38; F01P 3/14; F02F 1/242; F02F 1/4264; F01P 3/02; F01P 2003/024

(57) ABSTRACT

A water jacket for a cylinder head of an internal combustion engine includes a coolant chamber arranged to permit the flow of coolant within the water jacket and a coolant conduit positioned to permit the flow of coolant proximate to a recess for receiving an exhaust valve mounted to the cylinder head. The coolant conduit is in fluid communication with the coolant chamber, and the coolant conduit is shaped as a complex curve. A water jacket includes a pair of apertures arranged to receive a spark plug and a fuel injector. The apertures are separated by a separating member, and a coolant chamber is arranged to permit the flow of coolant about the apertures. The separating member includes a coolant channel in fluid communication with the coolant chamber so as to permit the flow of coolant between the apertures.

### REFERENCE TO RELATED APPLICATION

This application is a divisional of U.S. patent application Ser. No. 14/409,029 filed on Dec. 18, 2014, which is a United States National Phase application of PCT Application No. PCT/MY2013/000110 filed on Jun. 18, 2013, which claims priority to Malaysian Application No. PI 2012002752 filed on Jun. 18, 2012.

### FIELD OF THE INVENTION

The invention relates to internal combustion engines and, in particular, spray guided direct injection (SGDI) systems for the direct injection of fuel into the combustion chamber of such engines. Specifically, the invention relates to the flow of coolant within a cylinder head assembly of said internal combustion engine (ICE).

### BACKGROUND

Spray guided direct injection systems for internal combustion engines provide a lean stratified combustion, which has the dual advantage of reducing emissions as well as improving fuel efficiency. SGDI systems are characterized by having a centrally mounted direct injector with the spark plug mounted in close proximity to the injector.

In order to achieve this close proximity, the injector and spark plug are often packaged together and located at the top of the cylinder head so as to be intermediate the valves. This arrangement also allows for a compact design for the cylinder head assembly. This packaging results in the spark plug and injector being aligned so as to define a longitudinal plane that is parallel to the line of cylinders within the engine or a transverse plane that is orthogonal to the line of cylinders within the engine.

Whilst the SGDI technology is directed to reducing emissions for practical application to mainstream vehicles, it will be necessary to also offer high performance vehicles. As a result, for an engine incorporating SGDI technology such engines are generally more compact which affects the flow of coolant within the engine. When faced with achieving emission control, this is less critical than an engine requiring a higher power output as is required for high performance vehicles. Thus, with the application of SGDI technology to mainstream vehicles, the need to address heat buildup for poor conditions of the coolant will be a significant impediment.

Currently, mainstream vehicles producing significant power output are not restricted by a compact design and therefore the flow of coolant around the engine to address heat buildup is less of an issue. Increasing the size of the engine to accommodate the power output allows greater coolant flow including an increase in the size of coolant chambers around the cylinder head. Further, because of the increase in size, a lack of efficiency in providing the coolant flow paths is inherent.

A more compact design not only emphasizes a lack of efficient flow characteristics, it is further limited in providing sufficient coolant flow which may lead to localize increases in heat buildup affecting the performance in longevity of the engine.

### SUMMARY OF INVENTION

In a first aspect, the invention provides a water jacket for a cylinder head of an internal the flow of coolant within the water jacket. A coolant conduit is positioned to permit the flow of coolant proximate to a recess for receiving an exhaust valve mounted to the cylinder head, and the coolant conduit is in fluid communication with the coolant chamber. The coolant conduit is shaped as a complex curve.

Accordingly, in a first aspect, the invention seeks to provide a complex curve to the flow path around the exhaust valve bridge. The complex curve arrangement has two distinctive advantages being the removal of discontinuities in the flow path and the ability to shape the flow path around the exhaust valve bridge so as to minimize the material thickness between the valve and the coolant flow for better heat transfer characteristics.

With regard to discontinuities, typically a flow path according to the prior art involves drilling out a conduit and ensuring a sufficient size of the bore to allow the desired coolant flow rate. For large bore conduit, discontinuities are less critical than for compact engines such as those used in SGDI technology. Therefore, the use of a continuous flow path provided by a complex curve will reduce hydraulic losses that would otherwise impede the heat transfer effect.

Further, when drilling out a coolant conduit, the path must inherently be linear and so unable to follow the shape of the corresponding exhaust valve bridge recess cast into the cylinder head. It follows that whilst portions of a linear conduit may be at an optimum thickness, other portions will have a material thickness less than optimum and so being coolant conduit allows (i) a continuous flow path, (ii) the ability to optimize the material thickness, and (iii) the ability to optimize the bore of the conduit.

The complex curve may be a dual radius curve so as to flatten out the path as compared to a single radius curve.

Further, the complex curve may have several such curves applied therein having a finite radii. A further concern with the use of linear flow paths is the introduction of discontinuities between linear paths and between linear and curved paths. Unless specifically formed for the linear portion to be tangential, the interface between the linear portion and the curve portion will provide a discontinuous edge and consequently introduce hydraulic losses in the flow of the coolant. The interface between two linear paths will inevitably lead to a discontinuous surface.

Alternatively, the complex curve may be a double reverse curve to adjust the coolant path so as to emulate the shape of the exhaust valve bridge. Further still, the complex curve may be a spline, such as a Bezier spline, so as to best fit a continuous curve to the desired shape of the coolant path. This has the advantage of matching a desired arrangement of points along the coolant path whilst minimizing hydraulic losses and avoiding discontinuities. This may have the effect of optimizing the coolant path against a necessary shape of the water jacket, possibly due to size and shape restrictions within the engine.

In a still further embodiment, the complex curve may be two arcuate curves having a first radius in the range:

Θ/11<R1<Θ/13

5R1<R2<9R1

Where: Θ is the cylinder bore diameter,

R1 is the entry radius (142, FIG. 5B), and;

R2 is the exit radius (143, FIG. 5B).

In a second aspect, the invention provides a water jacket for a cylinder head of an internal combustion engine, the water jacket including a pair of apertures arranged to receive a spark plug and a fuel injector, the apertures separated by a separating member, and a coolant chamber arranged to permit the flow of coolant about the apertures. The separating member includes a coolant channel in fluid communication with the coolant chamber so as to permit the flow of coolant between the apertures.

Accordingly, the introduction of a coolant channel into the separating member provides, not only the benefit of coolant within a portion of the cylinder head, but also for better general coolant circulation around the coolant chamber.

In one embodiment, the separating member, having the coolant channel therein, may be a separable part which can be part of the assembly of the cylinder head. This will have the advantage of ease of manufacture of the coolant channel. Alternatively, the more difficult to cast, this allows for precise placement of the coolant channel for better heat control.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A and 1B are various views of a water jacket according to the prior art;

FIGS. 2A and 2B are isometric views of a water jacket according to one embodiment of the present invention;

FIGS. 3A and 3B are sectional views of a water jacket according to a further embodiment of the present invention;

FIG. 4A is a CFD image of a water jacket according to the prior art;

FIG. 4B is a CFD image of a water jacket according to a further embodiment of the present invention;

FIGS. 5A to 5C are various views of a water jacket according to a further embodiment of the present invention;

FIG. 6A is a detailed view of a water jacket according to the prior art;

FIG. 6B is a detailed view of a water jacket according to a further embodiment of the FIG. 7A is a CFD image of a water jacket according to the prior art; and

FIG. 7B is a CFD image of a water jacket according to a further embodiment of the present invention.

### DETAILED DESCRIPTION

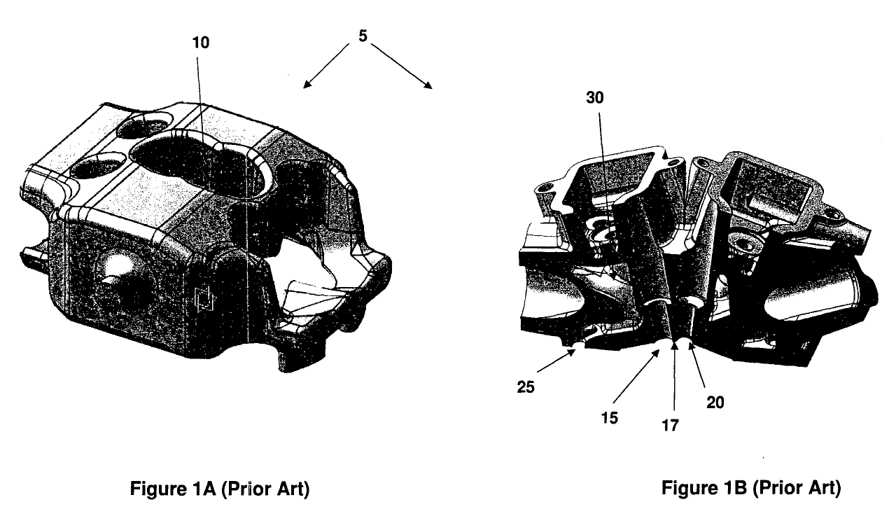

FIGS. 1A and 1B show a water jacket 5 according to the prior art whereby a recess 10 is to provide access to apertures 15, 20 for a spark plug and fuel injector (not shown).

In this arrangement, this could suit a water jacket for a cylinder head incorporating SGDI (Spray Guided Direct Injection) system for an internal combustion engine. In this case, the fuel injector and spark plug may be arranged in a substantially vertical position so as to provide a neater approach to the direct fuel injection. Consequently, the water jacket of FIG. 1A provides for a compact arrangement of the cylinder head consistent with an SGDI system.

The water jacket shown in FIG. 1B shows the coolant chamber 30 surrounding the apertures 15, 20 so as to cool the various components by circulating coolant within the chamber received from inlet 25. SGDI type systems involve a compact arrangement which suits the primary objective of controlling emissions. Heat build up within the cylinder head is not considered a primary objective. However, in order to introduce SGDI technology into main stream vehicles, they must also accommodate engines having a higher power output which consequently will lead to higher heat generation.

Of particular concern for an area involved in heat generation is the element 17 located between the apertures 15, 20. For a compact design, this area can be a source of heat generation if SGDI technology is directed to higher power output.

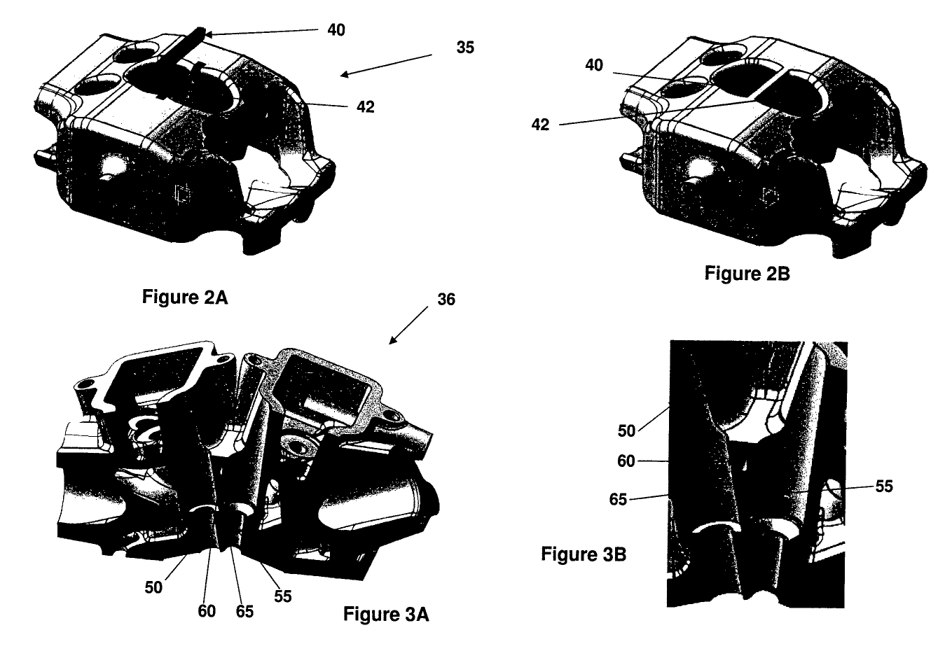

FIGS. 2A, 2B, 3A and 3B are water jackets according to various embodiments of the present invention. Here, the heat build up in the area intermediate the apertures for the spark plug and fuel injector have been addressed. In particular, for FIGS. 2 A and 2B provide a selectively multiple element 40 which acts as a separating member. In this embodiment, the removable separating member 40 includes a channel by the cast or drill into the member 40 so as to provide fluid communication between opposed zones of the coolant chamber. Thus, this linking function of the separating member 40 provides flow between the spark plug and injector apertures 50, 55 enhancing the coolant function.

FIGS. 3A and 3B show a different embodiment whereby the separating member 65 is a cast in place member having a coolant channel 60 either cast or drilled in place. Here the effect is the same by providing a channel through which coolant can flow between the apertures 50, 55 and so enhancing the coolant function of the coolant chamber applicable to the entire water jacket 36.

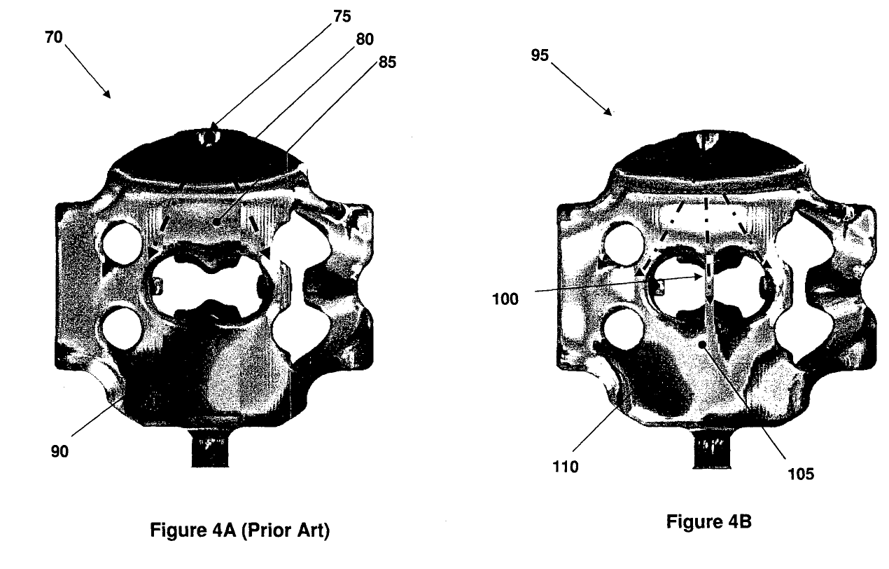

FIGS. 4A and 4B are computational fluid dynamics (CFD) images which demonstrate the benefit gained by providing a coolant channel through the separating member.

The CFD analysis calculates the flow rate of the coolant across the coolant channels (also referred as water jacket) in the engine both on the cylinder block and cylinder head. Requirement of high flow rate is more stringent near the combustion chamber area where the hottest part of the engine resides. This necessitates good cooling design especially on the area of exhaust valve bridge. Normal coolant flow rate along the cylinder head is between the range of 0.5 to 1.5 m/s, but for the critically hot region, flow rate of more than 2 m/s is desirable. Nonetheless, the flow rate can't be too fast due to metal erosion taking place at the flow rate of between 4 to 5 m/s in Aluminum depending on the casting method chosen.

FIG. 4A shows an entry point 75 for the coolant within the coolant chamber 85. Immediately surrounding the entry 80 is a high flow zone for the coolant providing significant cooling effect. The light regions about the coolant chamber show an efficient coolant function, however on the opposed side to the entry 75 is a darkened zone 90 which indicates a built up of heat through a lack of sufficient coolant flow from the entry side to the exit side of the coolant chamber.

FIG. 4B shows the effect of providing a separating member having a coolant channel 100. It will be seen that the area proximate to the apertures on the side opposed to the entry point shows good coolant flow and therefore more effectively cooling the water jacket 95. Whilst a darker zone 10 still exists this is much less prominent and therefore having much less effect on the performance of the water jacket.

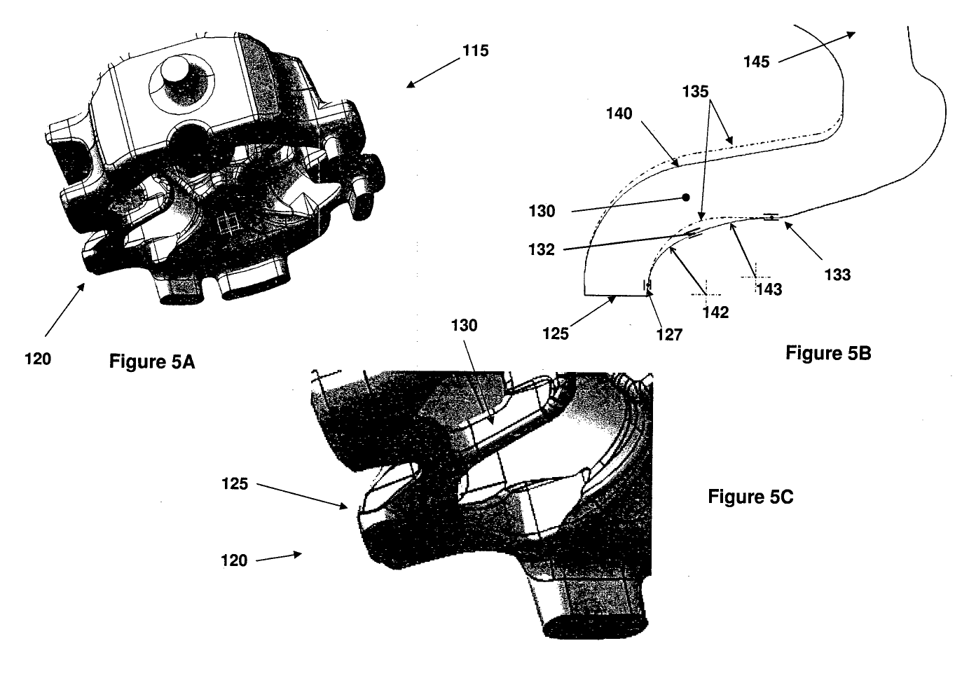

FIGS. 5A to 5C show various views of a water jacket 115 according a further embodiment of the present invention.

FIG. 5A shows an entry 120 for coolant into the coolant chamber of the water jacket 115. Prior to entering the coolant chamber 145 the coolant passes through a conduit 130, which is positioned above the exhaust valve bridge of the cylinder head (not shown). For high performance engine water jackets of the prior art, this conduit is typically drilled, leaving one or more linear sections of the conduit. As seen in FIG. 5B, the dotted lines 135 indicate the normal part for a prior art conduit showing linear portions and points of discontinuity 133 at various sections of the conduit.

As discussed, for prior art SGDI systems the need for efficient coolant flow is less important than meeting the primary objective of low emission control. Further for conventional high performance vehicles the engines tend to be much larger and so accommodate larger coolant systems having greater flow rate of coolant but consequently less efficient.

For an SGDI system requiring a compact construction of the cylinder head to accommodate the proximity of the spark plug and injector, the coolant chamber and the consequential conduits are much smaller and therefore will suffer through inefficient flow characteristics. For SGDI systems which are adapted for high performance vehicles this inefficient flow characteristic inevitably leads to excessive heat build up within the cylinder head. The present invention seeks to provide better flow a double reverse curve or curves of multiple arcs. Such a complex curve arrangement has a number of advantages including:

(i) to eliminate discontinuities within the coolant conduit;

(ii) to optimize material thickness within the water jackets so as to reduce material thickness between the coolant conduit and the heat sources, such the exhaust valve bridge;

(iii) optimize the size of the coolant conduit so as to increase the flow rate of coolant.

To this end, the coolant conduit 130 includes shaped path 140 so as to guide the flow coolant into the coolant chamber 145. In this embodiment, the shape is formed from a dual radius curve R1 142 proximate the point of entry 125 and R2 143 proximate the point of exit 145. The dual radius curve is then shaped into the remaining coolant conduit through entry, intermediate and exit tangents 127, 132, 133.

Such an arrangement may have the radii in the relationship of:

Θ/11<R1<Θ/13

5R1<R2<9R1

Where: Θ is the cylinder bore diameter
R1 is the entry radius; and
R2 is the exit radius.

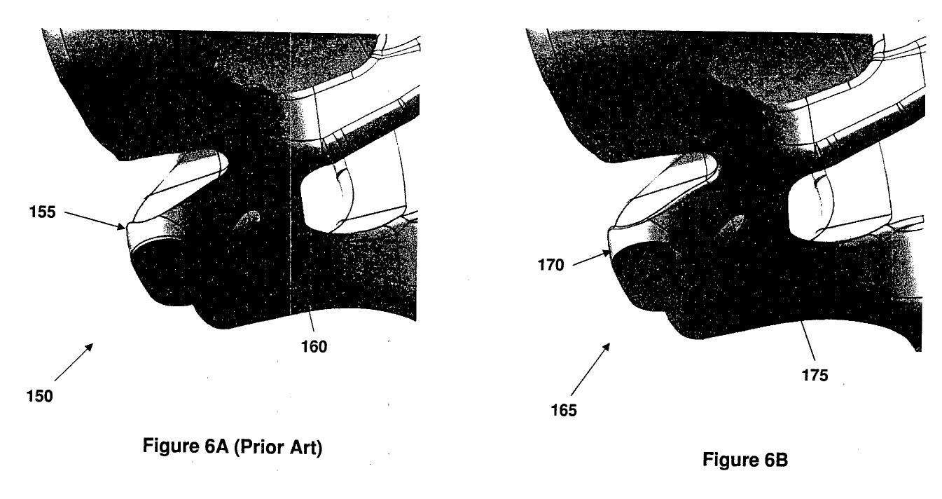

FIGS. 6A and 6B show an external view of a casting of a water jacket whereby the coolant conduit has been optimize using a complex curve arrangement according to the present invention.

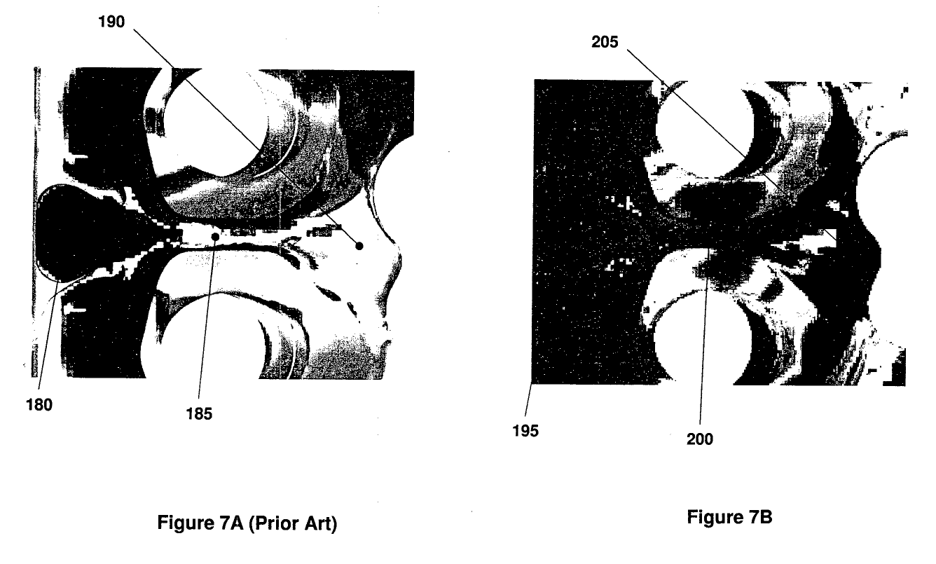

FIGS. 7A and 7B demonstrate the benefits of such an approach. These figures show CFD images according to the prior art (FIG. 7A) as well as using a complex curve arrangement within the coolant conduit according to the present invention (FIG. 7B).

The images shown in FIGS. 7A and 7B represent the projected flow rate of coolant, with the darker portions showing a faster flow rate and lighter portions showing a slower flow rate. At the entry point into the water jacket 180, 195 for the coolant the rate is clearly very high showing a darker portion. However, the portion through the coolant conduit 185 for the prior art and its entry into the coolant chamber 190 are considerably lighter showing a dramatic reduction in flow rate. By contrast the flow rate is maintained through the coolant conduit 200 and into the coolant chamber 205 as demonstrated by a consistent dark pattern throughout the coolant conduit.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A water jacket for a cylinder head of an internal combustion engine, the water jacket comprising:
a coolant chamber arranged to permit a flow of a coolant within a water jacket; and
a coolant conduit positioned to permit the flow of the coolant proximate to a recess for receiving an exhaust valve mounted to a cylinder head, said coolant conduit in fluid communication with the coolant chamber, wherein said coolant conduit is shaped as a complex curve.

2. The water jacket according to claim 1, wherein each curve within the complex curve has a finite radius.

3. The water jacket according to claim 1, wherein the complex curve is one or a combination of: a double reverse curve, a spline or a dual radius curve.

4. The water jacket according to claim 3, wherein the complex curve is a double radius curve having the relationship θ/11<R1<θ/13 and 5R1<R2<9R1, where θ is the cylinder bore diameter, R1 is an entry radius, and R2 is an exit radius of said coolant conduit.

5. The water jacket according to claim 1, wherein the complex curve is shaped such that a portion of said curve corresponds to a shape of said exhaust valve recess.
